(19) United States
(12) Patent Application Publication
(10) Pub. No.: US 2024/0074626 A1
(43) Pub. Date: Mar. 7, 2024

(54) Recyclable Package for Containing Premoistened Wipes

(71) Applicant: Kimberly-Clark Worldwide, Inc., Neenah, WI (US)

(72) Inventor: Matthew Kensall, Westcliff on Sea, Essex (GB)

(21) Appl. No.: 18/261,851

(22) PCT Filed: Feb. 26, 2021
(86) PCT No.: PCT/US2021/019906

§ 371 Date: Jul. 18, 2023

(51) Int. Cl. A47K 10/42; B65D 43/02; B65D 65/40; B65D 65/42; B65D 65/46; B65D 75/12; B65D 75/58; B65D 83/08

(52) U.S. Cl. CPC A47K 10/421; B65D 43/0202; B65D 65/40; B65D 65/42; B65D 65/466; B65D 75/12; B65D 75/58; B65D 83/0805; A47K 2010/3266; B65D 2543/00194; B65D 2565/385; B65D 2575/586

(57) ABSTRACT

A package for containing premoistened wipes including a top package wall opposite a bottom package wall comprising a biodegradable web and the top package wall defining an opening surrounded by an edge of the biodegradable web for dispensing premoistened wipes therethrough. A baffle attached to the top package wall comprising a polymer film surrounding the edge of the biodegradable web including a passageway configured to permit permoistened wipes to be removed from the package without contacting the edge of the biodegradable web. In one embodiment, the package is primarily made from cellulose fiber materials laminated with a polymer film. The paper material can be printed and die cut prior to the lamination of the polymer film to produce an opening for dispensing wipes. The polymer film can form a smaller aperture within the opening cut into the cellulose fiber material for protecting the edges of the cellulose fiber material from moisture.

### BACKGROUND

Wet wipes or premoistened wipes are used in a variety of applications in order to clean or wipe a surface. For example, many premoistened wipes are sold in stacks as baby wipes that are used during diaper changes or otherwise used to remove food and/or dirt from the skin of an infant or toddler. Wet wipes are also available containing antimicrobial compositions. These types of wipes have grown in importance during the Covid pandemic. For example, many antimicrobial wipes are capable of destroying the Corona virus on contact.

Most premoistened wipes are sold in stacks and are disposable. For instance, premoistened wipes are typically used only once and then discarded. In this regard, those skilled in the art have recently designed premoistened wipes that are recyclable and/or biodegradable. For example, instead of making the wipes from petroleum-based polymers, wet wipes have been made from renewable resources, such as cellulosic fibers, bio-based fibers, and water-soluble fibers. For example, one embodiment of a water-dispersible premoistened wiping product is disclosed in U.S. Pat. No. 7,378,360, which is incorporated herein by reference.

Although many great advances have occurred in the art in order to produce biodegradable or water-dispersible premoistened wipes, the packages in which the wipes are shipped, stored and sold are still typically made from petroleum-based polymers and films. Thus, a need currently exists for a package for premoistened wipes that is recyclable and/or biodegradable so that the entire product is environmentally friendly.

### SUMMARY

The present disclosure is generally directed to a package designed to contain premoistened wipes that is made from recyclable and/or biodegradable materials. More particularly, the package is made from a biodegradable web. The biodegradable web can be made from any suitable material, such as cellulose fiber. In one aspect, the biodegradable web is a paper. In order to protect the biodegradable web from the saturating solution contained in the premoistened wipes, at least one liquid-resistant layer is incorporated into the package including a baffle made from a polymer film that protects exposed biodegradable material, such as a cellulose material, from the saturating liquid.

For example, in one aspect, the present disclosure is directed to a package for premoistened wipes. The package comprises a container defining a hollow enclosure for receiving premoistened wipes. The container includes at least a top package wall opposite a bottom package wall. The top package wall and the bottom package wall are each made from a biodegradable web, such as a cellulose fiber web. The biodegradable web can be a paper or paperboard. The biodegradable web includes a first side and a second side. The first side of the web, in one embodiment, can be bonded to a liquid-resistant layer. The first side of the biodegradable web or cellulose fiber web can face the hollow enclosure of the container.

The top package wall defines an opening for dispensing premoistened wipes therethrough. The opening is surrounded by an edge of the biodegradable web or cellulose fiber web. The package further includes a baffle attached to the first side of the top package wall. The baffle comprises a polymer film. The baffle surrounds the edge of the biodegradable web or cellulose fiber web that defines the opening. The baffle includes a passageway configured to permit premoistened wipes to be removed from the package without contacting the edge of the biodegradable web or cellulose fiber web. The passageway defined by the baffle can, in one embodiment, be one or more slits. In an alternative embodiment, the passageway can be an aperture. The aperture can have a circumference or diameter that is less than the circumference or diameter of the opening defined by the top package wall. The baffle can be made from any suitable polymer film, including bio-based polymers. In one embodiment, the polymer film is made from a polyolefin polymer, such as a low density polyethylene polymer. When made from a polyolefin polymer, however, the total amount of polyolefin polymers contained in the package remains below 5% by weight.

In one aspect, the baffle can cover the entire first side of the biodegradable web or cellulose fiber web and serve as the liquid resistant layer that forms the interior surface of the package facing the premoistened wipes. Alternatively, the baffle may only extend over a portion of the first side of the biodegradable web or cellulose fiber web. In this embodiment, the biodegradable web or cellulose fiber web may be bonded to a separate liquid resistant layer such as a polymer film or coating.

The package further includes a removable lid that covers the opening defined by the top package wall. The removable lid can also be made from a paper or paperboard material. The lid can include a first side and an opposite second side. An adhesive can be applied to the first side of the lid for removably adhering to the second side of the top package wall covering the opening. In one aspect, the second side of the top package wall can include a release layer that surrounds the opening for facilitating removal of the lid in order to dispense premoistened wipes. The release layer can comprise a coating, such as a varnish.

In one embodiment, the baffle can be pre-cut to define an aperture and to form a cut-out portion within the package. When the removable top is first removed from the package, the cut-out portion adheres to the adhesive on the removable top for preventing adhesive corresponding to the opening from becoming attached to the wipe, a user's hand, contaminants, debris, or the like.

The top package wall can have a length and a width. In one aspect, the baffle can extend the entire length and width of the top package wall. The baffle can also extend over the entire width of the top package wall or can extend only over a portion of the top package wall. The ends of the package can be heat-sealed by applying heat and pressure to the polymer film that comprises the baffle. In one embodiment, the package can include a heat-sealed first end, a heat-sealed second end, and a heat-sealed fin seal that extends the length of the package.

In one embodiment, the top package wall and the bottom package wall can both be made from flexible materials. Alternatively, the top package wall and the bottom package wall can be made from a rigid or semi-rigid material.

In order to produce the package, in one aspect, a roll of biodegradable material is cut to produce a plurality of openings. After the openings are cut into the biodegradable material, the baffle can be laminated to the first side of the biodegradable material. The baffle can be made from a polymer film, such as a low density polyethylene film, that is liquid-resistant and capable of forming thermal bonds. The baffle can cover the entire surface or a portion of the surface of the first side of the biodegradable material.

A release layer can be applied to the second side of the biodegradable material around the openings. The release layer can be a coating applied to the biodegradable material. The roll of material can be unwound and cut into individual sheets, formed into a package, loaded with premoistened wipes, and then sealed, such as heat sealed. For instance, the laminated material can be formed into a tube around a stack of premoistened wipes and heat sealed at each end and along the length of the package to form a fin seal.

In one embodiment, as the package is filled and sealed, an aperture can be formed into the baffle. For instance, the baffle can be cut while simultaneously applying a self-adhesive lid to the top of the package. The cutout portion of the baffle can remain within the package. For example, the interior surface of the lid can be completely coated with the adhesive.

When the lid is initially opened by a user, the cutout portion can adhere to the lid that protects the underside of the lid. As the user dispenses premoistened wipes from the package, the baffle prevents the premoistened wipe from contacting the edges of the opening of the biodegradable material.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of one embodiment of a package for premoistened wipes made in accordance with the present disclosure;

FIG. 2 is a perspective view of the package illustrated in FIG. 1 showing a top lid in an open configuration in order to dispense premoistened wipes;

FIG. 3 is a perspective view of a roll of material that can be used to construct the package illustrated in FIGS. 1 and 2; and

FIG. 4 is a perspective view of an alternative embodiment of a roll of material that may be used to produce packages in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to sustainable packaging for premoistened wipes. More particularly, the present disclosure is directed to a package for premoistened wipes that is made from renewable, recyclable, and/or biodegradable materials. In one aspect, for instance, the package made according to the present disclosure, once emptied, can be collected and processed through the recycling stream, such as the paper recycling stream.

For example, the package of the present disclosure can be made from a biodegradable web including cellulose fiber webs, such as a paper or a paperboard. Although paper products are made from renewable resources that are recyclable and biodegradable, paper is a naturally porous material making the material incompatible as a packaging material for premoistened wipes. Consequently, in accordance with the present disclosure, in order to use a paper material as packaging, the paper material is coated and/or laminated with a liquid resistant barrier on the inside of the package. The package further includes an aperture for dispensing the premoistened wipes therethrough. The opening, however, exposes the cellulose fibers which can wick away or draw in moisture from the wipes and cause the package to wrinkle, degrade and ultimately fail. Thus, in addition to water resistant barrier layers, the package of the present disclosure further includes an integral baffle that keeps moisture away from the edges of the biodegradable material or paper layer surrounding the dispensing opening. In addition to protecting the paper layer, the baffle can also be used to heat seal the package and facilitate opening and closing of the package.

For example, in one embodiment, the baffle, which can comprise a polymer film, can be laminated to the top package wall and cover a precut opening that is for dispensing the premoistened wipes. The polymer layer is then cut to produce a passageway that allows wipes to be removed from the package without contacting the edges of the biodegradable web or paper surrounding the opening. For instance, as the package is being filled with premoistened wipes and heat sealed, in one embodiment, an aperture that is smaller than the opening in the top package wall can be die cut while simultaneously applying a self-adhesive lid. The amount of polymer film incorporated into the product can be carefully controlled so that, even if the polymer film is made from a petroleum-based polymer, the product still meets all governmental requirements for approval to enter the paper recycling stream.

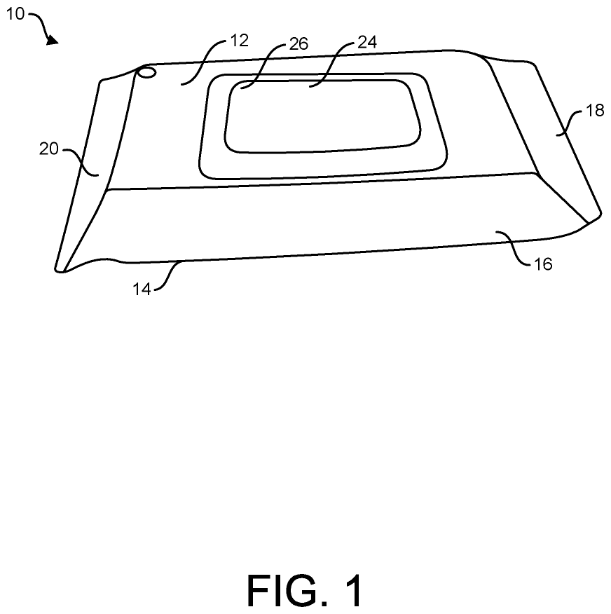

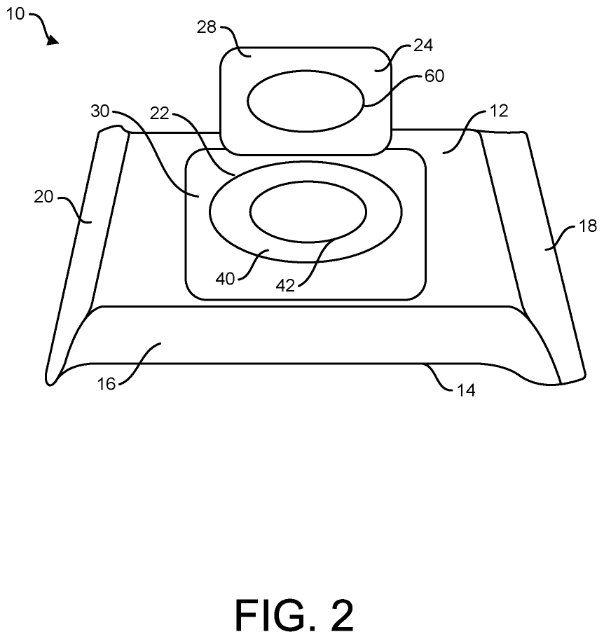

Referring to FIGS. 1 and 2, one embodiment of a package 10 made in accordance with the present disclosure is shown. As will be described in greater detail below, the package 10 is primarily made from a biodegradable material, such as cellulose fibers. Thus, the package is not only made from renewable resources but is also substantially biodegradable and capable of being recycled. As shown in FIGS. 1 and 2, the package 10 includes a top package wall 12 opposite a bottom package wall 14. The package 10 can also include one or more side walls 16. The package 10 can be made from a single continuous strip of material or can be made from separate pieces of material that are connected together. In the embodiment illustrated in FIGS. 1 and 2, for instance, the package 10 is made from a single continuous piece of material. The package 10 includes a first sealed end 18 opposite a second sealed end 20. Not shown, the package 10 can also include a fin seal that extends from the first end 18 to the second end 20 along the bottom package wall 14. The fin seal is formed by bonding together the piece of material used to form the package along the length of the package.

The package 10 defines a hollow enclosure for receiving premoistened wipes, such as a stack of premoistened wipes. As used herein, the term a “premoistened wipe” refers to a fibrous sheet that has a liquid applied thereto. The amount of liquid or solution contained within each wet wipe can vary depending upon the type of material being used to provide the wet wipe, the type of liquid being used, and the desired end use of the wet wipe. Generally, each wet wipe can contain from about 25 weight percent to about 600 weight percent or from at least about 70 weight percent to less than about 400 weight percent liquid based on the dry weight of the wipe. To determine the liquid add-on, first the weight of a dry wipe is determined.

The premoistened wipes, for instance, can include a base sheet that is saturated with a cleaning or wiping solution. In general, the base sheet can comprise any suitable porous wiping substrate. Desirably, the base sheet has a soft and pleasing hand and remains resiliently compressible when wet. The base sheet may be made from continuous fibers, stable length fibers, or combinations thereof. In one embodiment, the base sheet is made from renewable resources, is recyclable, and/or is biodegradable. For instance, the base sheet can be made from natural fibers, such as wood pulp fibers, cotton fibers, bamboo fibers, hemp fibers, and the like. The base sheet may contain a minimal amount of synthetic fibers. Alternatively, the base sheet can be made from synthetic fibers that are water soluble or otherwise biodegradable, such as rayon fibers.

The base sheet can comprise a woven, knit or nonwoven fabric. The base sheet may be a single layer base sheet or can comprise a laminate. Suitable base sheets will have a dry basis weight of from about 25 gsm to about 175 gsm.

Particular embodiments of base sheets that may be contained within the package 10 include air-laid nonwoven webs, wet-laid webs, coform webs, hydroentangled webs, and the like.

In general, any suitable wiping or cleaning solution can be impregnated into the base web. In one aspect, the cleaning or wiping solution can also be environmentally friendly. For example, in one embodiment, the solution impregnated into the base web can be water or an aqueous solution. When the wet wipe is for applying to the skin of the user, for instance, the solution can contain water in combination with one or more surfactants. When used in a disinfecting application, on the other hand, the solution can contain water combined with at least one disinfectant. The disinfectant, for instance, can be an alcohol. Other additives that can be present in the solution include antiseptics, emollients, skin conditioners, virucides, antibiotics, fragrances, anti-drying agents, and the like.

The package 10 as shown in FIGS. 1 and 2 includes an interior surface that defines the hollow enclosure. The interior surface of the package is in direct contact with the one or more premoistened wipes contained in the hollow enclosure. In this regard, the package 10 of the present disclosure is specifically designed so that the package will not degrade or fail when contacted with the wiping solution contained within the premoistened wipes.

In one embodiment, the top package wall 12, the bottom package wall 14, and any side wall 16 are made from a biodegradable web, such as a cellulose fiber web that includes a first side and an opposite second side. The first side of the cellulose fiber web is bonded to a liquid-resistant layer. The liquid-resistant layer faces the hollow enclosure and is designed to contact the premoistened wipes contained within the package 10.

In one aspect, the cellulose fiber layer is a paper or paperboard. For instance, the cellulose fiber web can be a wet-laid paper layer. The walls of the package 10 can be made from a single layer paper material bonded to the liquid-resistant layer or can comprise a multi-layer laminate containing paper layers alone or in combination with other types of layers. The walls can also be flexible, semi-rigid, or rigid. When flexible, the Gurley stiffness of the package material (as measured by ASTM D 6125-97 “Standard Test Method for Bending Resistance of Paper and Paperboard”) can be about 10,000 milligrams of force (mgf) or less, more specifically from about 100 to about 8000 mgf, more specifically from about 200 to about 6500 mgf, and still more specifically from about 300 to about 1500 mgf.

In one aspect, the second side of the top package wall 12, the bottom package wall 14, and any side wall 16 that form the exterior surface of the package 10 are ink or print receptive. For instance, the exterior surface of the package can be printed with decorations, information, trademarks, and the like.

The liquid-resistant layer bonded to the first side of the biodegradable web, such as a cellulose fiber web, can comprise a film that has been laminated to the web or can be a coating applied to the web. In one aspect, the liquid-resistant layer is made from a polymer. For example, suitable polymers include polyolefins, such as polypropylene or polyethylene. In one particular aspect, the liquid-resistant layer is a low-density polyethylene layer.

Other polymers that may be used include high density polyethylene, medium density polyethylene, linear low density polyethylene, or the like. When the liquid-resistant layer is a coating, the liquid-resistant layer can be an ethylene acrylic acid copolymer, an ethylene-methacrylic acid copolymer, or a polymer having an active carboxylic acid group. For example, the coating can be made from a maleic anhydride functionalized polyolefin.

As shown in FIGS. 1 and 2, the top package wall 12 defines an opening 22. The opening 22 is for dispensing the premoistened wipes. The package also includes a lid 24 that covers the opening 22. The lid 24 is shown in a closed position in FIG. 1 and in an open position in FIG. 2. Similar to the package 10, the lid 24 can also be formed from a biodegradable web, such as a cellulose fiber web. The lid 24 can include an exterior surface 26 and an interior surface 28 that faces the hollow enclosure of the package 10. The interior surface 28 can be treated with an adhesive, such as a pressure sensitive adhesive that enables the lid 24 to be releasably opened and closed as premoistened wipes are dispensed. In order to facilitate opening and closing of the lid 24, the package 10 can also include a release layer 30. The release layer 30 can be made from a material that adheres to the adhesive on the interior surface 28 of the lid 24 but also facilitates release of the adhesive from the package 10. The release layer 30, for instance, can be made from any suitable material, such as a layer or coating. The release layer 30, for instance, can comprise a varnish applied to the top package wall 12. In one embodiment, the release layer can comprise a silicone material.

As shown particularly in FIG. 2, the opening 22 exposes the edges of the biodegradable web or cellulose fiber web of the top package wall 12. As wet wipes are dispensed from the package 10, wiping solution can be absorbed by the cellulose fiber web along the edges of the opening 22. In order to protect the edge of the cellulose fiber web of the top package wall 12, the package 10 further includes a baffle 40. The baffle 40 is made from a liquid-resistant layer and is positioned on the first side of the top package wall 12 that faces the hollow enclosure of the package 10. In one aspect, the baffle 40 is made from a polymer film. The baffle 40 protects the edges of the top package wall 12 surrounding the opening 22 during dispensing of the premoistened wipes from the package 10.

As shown in FIG. 2, in one embodiment, the baffle 40 defines an aperture 42 for dispensing premoistened wipes therethrough. The aperture 42 has a circumference or diameter that is shorter than the circumference or diameter of the opening 22. In this manner, the baffle 40 forms a protective liquid-resistant margin around the opening 22. In one aspect, for instance, the distance between the edge of the opening 22 and the edge of the aperture 42 is greater than about 2 mm, such as greater than about 5 mm, such as greater than about 10 mm, such as greater than about 15 mm, such as greater than about 20 mm, such as greater than about 25 mm, and generally less than about 50 mm, such as less than about 40 mm, such as less than about 30 mm.

In general, the area of the opening 22 can be greater than about 3 cm², such as greater than about 8 cm², such as greater than about 10 cm², such as greater than about 12 cm², such as greater than about 15 cm², such as greater than about 20 cm², such as greater than about 25 cm², such as greater than about 30 cm². The area of the opening 22, in one aspect, can be less than about 45 cm², such as less than about 40 cm², such as less than about 35 cm², such as less than about 30 cm², such as less than about 25 cm², such as less than about 20 cm². The area of the passageway or aperture 42 defined by the baffle can be at least about 3% less, such as at least about 5% less, such as at least about 8% less, such as at least 10% less, such as at least about 15% less, such as at least about 20% less than the area of the opening 22 defined by the top package wall. The area of the passageway or aperture 42 defined by the baffle can be no more than about 80% less, such as no more than about 60% less, such as no more than about 40% less than the area of the opening defined by the top package wall.

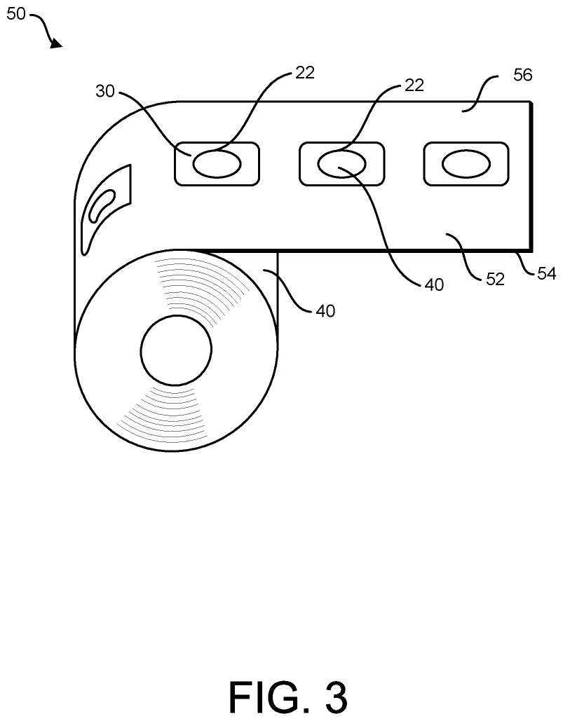

The package 10 as shown in FIGS. 1 and 2 can be constructed in various different ways. In one embodiment, for instance, the package 10 can be made from a single roll of material 50 as shown in FIG. 3. The roll of material 50 as shown in FIG. 3 includes a biodegradable material, such as a cellulose fiber material 52, having a first side 54 and an opposite second side 56. The first side 54 of the cellulose fiber material 52 is designed to face the hollow enclosure of the package 10 when the cellulose fiber material 52 is formed into the package.

In one embodiment, in order to form the package 10 as shown in FIGS. 1 and 2, the cellulose fiber material 52 is first die cut to produce the opening 22 as shown in FIG. 3. If desired, the cellulose fiber material 52 can also be printed with any information, advertisements, trademarks, designs and the like.

After the openings 22 are cut into the cellulose fiber material 52, the baffle 40 can be laminated to the first side 54 of the cellulose fiber material 52. The baffle 40 can be made from a polymer film, such as a low density polyethylene film, that is liquid-resistant and capable of forming thermal bonds. In the embodiment illustrated in FIG. 3, the baffle 40 covers the entire surface of the first side 54 of the cellulose fiber material 52. As shown in FIG. 3, the baffle 40 can be viewed through the openings 22.

The release layer 30 can be applied to the second side 56 of the cellulose fiber material 52 around the openings 22. The release layer 30 can be a coating applied to the cellulose fiber material 52 or can be a piece of material that is laminated to the cellulose fiber material 52. In one embodiment, the release layer 30 comprises a varnish.

The roll of material 50 can then be fed into a process for producing the package 10. In particular, the roll of material 50 can be cut into individual sheets, formed into the package 10, loaded with premoistened wipes, and then sealed, such as heat sealed. In the embodiment illustrated in FIG. 3, the baffle 40 not only protects the opening 32 during use of the package 10 but also allows for the edges of the material 50 to be heat sealed together. As shown in FIGS. 1 and 2, for instance, the material 50 can be formed into a tube around a stack of premoistened wipes and heat sealed at each end and along the length of the package to form a fin seal.

In one embodiment, as the package is filled and sealed, the aperture 42 can be formed into the baffle 40. For instance, the baffle 40 can be die cut while simultaneously applying the self-adhesive lid 24 to the top of the package 10. The cutout portion of the baffle 40 can remain within the package. For example, the interior surface 28 of the lid 24 can be completely coated with the adhesive. When the lid 24 is initially opened, a cutout portion 60 as shown in FIG. 2 can adhere to the lid 24. The cutout portion 60 protects the underside of the lid 24.

Alternatively, instead of forming an aperture 42 in the baffle 40, the baffle 40 can be scored to form one or more slits within the circumference of the opening 22. One can then remove premoistened wipes through the slits during use of the package.

In the embodiment illustrated in FIG. 3, the baffle 40 covers the entire first side 54 or bottom surface of the cellulose fiber material 52. In alternative embodiments, however, the baffle may only cover portions of the surface of the first side 54 of the cellulose fiber material 52. For instance, in an alternative embodiment, the cellulose fiber material 52 can include an additional liquid-resistant layer applied to the first side 54 of the cellulose fiber material 52. The liquid-resistant layer, for instance, can not only protect the material from liquids but can also comprise a material capable of being heat sealed.

For example, in one embodiment, the cellulose fiber material 52 is a laminate that includes on the first side 54 a liquid-resistant layer. In this embodiment, the openings 22 can be formed in the material 52 and then covered with a baffle material. The baffle material, for instance, can be in the form of individual pieces that are attached to the underside of the opening 22.

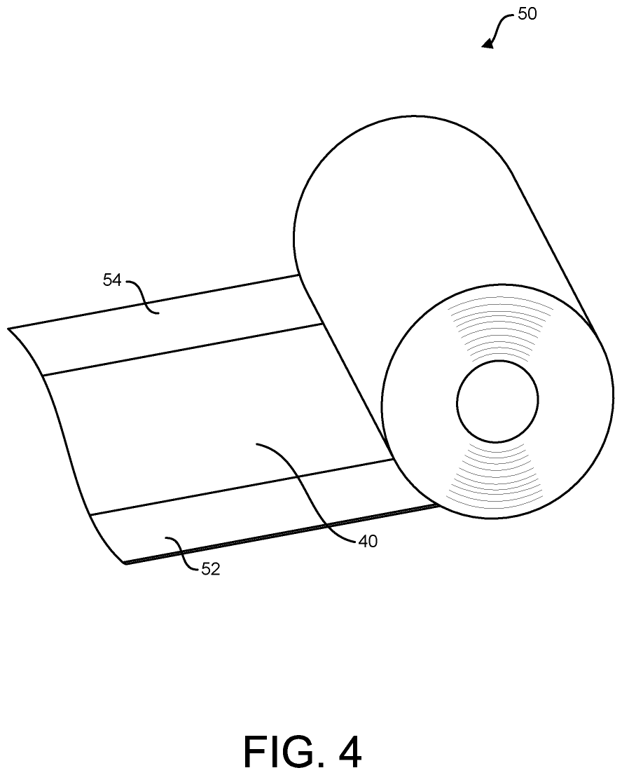

In another embodiment as shown in FIG. 4, the baffle 40 can extend along the entire length of the cellulose fiber material 52 but only extend over a portion of the width of the cellulose fiber material 52. The width of the baffle 40 can be sufficient to cover the opening 22 as shown in FIG. 2. In the embodiment illustrated in FIG. 4, the baffle 40 is available to heat seal the ends of the package but not along the length of the package. The length of the package, for instance, can be heat sealed using a separate water-resistant layer.

In still another embodiment, the ends of the package and the length of the package, instead of being heat sealed, can be sealed using an adhesive, such as an environmentally friendly adhesive.

The package can have any suitable dimensions and volume. For instance, in one aspect, the package can have a length of from about 16 cm to about 23 cm, a width of from about 8 cm to about 14 cm, and a thickness of from about 1 cm to about 12 cm.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

1. A package for containing premoistened wipes comprising:
a container defining a hollow enclosure for receiving premoistened wipes, the container including at least a top package wall opposite a bottom package wall, the top package wall and the bottom package wall comprising a biodegradable web having a first side and an opposite second side, the first side of the biodegradable web facing the hollow enclosure, the top package wall defining an opening for dispensing premoistened wipes therethrough, the opening being surrounded by an edge of the biodegradable web;
a baffle attached to the first side of the top package wall, the baffle comprising a polymer film, the baffle surrounding the edge of the biodegradable web that defines the opening, the baffle including a passageway configured to permit premoistened wipes to be removed from the package without contacting the edge of the biodegradable web;
a removable lid covering the opening defined by the top package wall; and
at least one premoistened wipe contained in the hollow enclosure.

2. A package as defined in claim 1, wherein the biodegradable web comprises a cellulose fiber web.

3. A package as defined in claim 1, wherein the opening of the top package wall has a circumference and wherein the passageway on the baffle comprises an aperture, the aperture having a circumference that is smaller than the circumference of the opening.

4. A package as defined in claim 1, wherein the passageway on the baffle comprises at least one slit.

5. A package as defined in claim 1, wherein the baffle comprises a polyolefin film.

6. A package as defined in claim 5, wherein the polyolefin film comprises a low density polyethylene film.

7. A package as defined in claim 1, wherein the package contains one or more polyolefin polymers in an amount less than 5% by weight.

8. A package as defined in claim 1, wherein the lid comprises a paper layer.

9. A package as defined in claim 1, wherein the lid has a first side and an opposite second side and wherein an adhesive has been applied to the first side of the lid, the adhesive removably adhering the first side of the lid to the second side of the top package wall surrounding the opening.

10. A package as defined in claim 9, wherein the second side of the top package wall includes a release layer surrounding the opening, the release layer removably adhering to the adhesive applied to the first side of the lid.

11. A package as defined in claim 9, wherein the baffle is pre-cut to define an aperture and to form a cut-out portion within the package, and wherein the cut-out portion adheres to the adhesive applied to the removable top.

12. A package as defined in claim 10, wherein the release layer comprises a coating.

13. A package as defined in claim 12, wherein the coating comprises a varnish.

14. A package as defined in claim 1, wherein the top package wall has a length and a width and wherein the baffle extends the entire length of the top package wall.

15. A package as defined in claim 14, wherein the baffle also extends over the entire width of the top package wall.

16. A package as defined in claim 1, wherein the walls of the package are formed from a single piece of biodegradable web that as been laminated to the baffle, the baffle defining an interior surface of the package surrounding the hollow enclosure.

17. A package as defined in claim 14, wherein the baffle extends only over a portion of the width of the top package wall and wherein the top package wall and the bottom package wall further comprise a liquid resistant layer bonded to the first side of the top package wall and the first side of the bottom package wall.

18. A package as defined in claim 1, wherein outer edges of the package are heat-sealed by applying heat and pressure to the polymer film.

19. A package as defined in claim 1, wherein the top package wall and bottom package wall are flexible.

20. A package as defined in claim 1, wherein the top package wall and the bottom package wall are rigid or semi-rigid.

21. A package as defined in claim 9, wherein the adhesive applied to the first side of the lid is water-soluble.
